(19) United States
(12) Patent Application Publication
(10) Pub. No.: US 2007/0065772 A1
(43) Pub. Date: Mar. 22, 2007

(54) PORTABLE DENTAL CARE STAND

(76) Inventor: JANG HYUN YANG, GEYONGGI-DO (KR)

Correspondence Address: IPLA P.A., 3580 WILSHIRE BLVD., 17TH FLOOR, LOS ANGELES, CA, 90010, US

(21) Appl. No.: 10/595,689

(22) PCT Filed: Nov. 1, 2004
(86) PCT No.: PCT/KR04/02777

§ 371 Date: May 4, 2006

(30) Foreign Application Priority Data
Nov. 4, 2003 (KR) 10-2003-0077472

(51) Int. Cl. A61C 13/38

(52) U.S. Cl. 433/77

(57) ABSTRACT

The present invention m provides a portable dental care stand. The portable dental care stand includes: a cover part having a handle formed at an upper portion; a machine part connected with the cover part by using a separable hinge, and the machine part having: an upper plate covering an upper portion of a rectangular housing, which is opened at the upper portion and a lower portion, a rectangular machine chamber having an opened upper portion and disposed at a predetermined removed portion of the upper plate, an operation panel having a predetermined slanting surface and installed at the opened upper portion of the machine chamber, the operation panel having a plurality of operation buttons at the slanting surface, and a mount installed using a sliding member at a lower end of the maching chamber; a rectangular box part having an opened upper portion and connected with the machine part by using a spreadable or foldable leg part; and hooks installed at a front and rear of the machine part and the box part to couple the machine part with the box part.

### TECHNICAL FIELD

The present invention relates to a portable dentalcare stand, and more particularly, to a portable dental care stand in which a dental care equipment can be easily and safely moved, thereby making it possible to perform the dental care even in an outside environment.

### BACKGROUND ART

Use of proper tool according to need is an essentialelement for medical examination and treatment. Accordingly, many equipments are installed at a dental clinic to operate on one mount

A dental clinic equipment should mainily supply airor water to an end of one tool, and should remove saliva or water from a mouth%y using a tool such as a suction.

### DISCLOSURE OF THE INVENTION

### Technical Problem

However, in case where a dental doctor should directly visit a patient since the patient cannot be moved to the dental clinic or be at an isolated place, there is a difficulty in that due to an improper equipment, it takes a long time to treat the patient and treatment is poorly performed even though the dental doctor carries some separated equipments for treatment

### Technical Solution

Accordingly, the present invention is directed to a portable dental care stand that substantially obviates one or more of the problems due to limitations and disadvantages of the related art.

An abject of the present invention is to provide a portable dental care stand in which a dental care can be well performed in an outside environment, a machine part is provided to connect a dental clinic tool, and an equipment can be protected when the dental care stand is moved.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

### Advantageous Effects

The dental care stand according to the present invention has an effect in that since the dental clinic tools can be connected to the machine part, the same dental clinic tools as those of a dental clinic cannot only be used even in an outside environment to perfectly perform the dental care, but also the equipment can be protected when the dental care stand is moved.

### BRIEF DESCRIPTION OF THE DRAWINGS

The accompanying drawings, which are included to provide a further understanding of the invention and are incorporated in and constitute a part of this specification, illustrate embodiments of theinvention and together with the description serve to explain the principles of the invention.

In the drawings:

FIG. 1 is a perspective view illustrating a potable dental care stand according to one embodiment of the present invention;

FIG. 2 is a view illustrating a used state of aportable dental care stand according to one embodiment of the presentinvention;

FIG. 3 is a sectional view illustrating a portable dental care stand mounted on a mount according to one embodiment of the presentinvention; and

FIG. 4 is a perspective view illustrating a potable dental care stand according to another embodiment of the present invention.

### BEST MODE FOR CARRYING OUT THE INVENTION

A portable dental care stand comprising: a cover part having a handle formed at an upper portion; a machine part connected with the cover part by using a separable hinge, and the machine part having: an upper plate covering an upper portion of a rectangular housing, which is opened at the upper portion and a lower portion, a rectangular machine chamber having an opened upper portion and disposed at a predetermined removed portion of the upper plate, an operation panel having a predetermined slanting surface and installed at the opened upper portion of the machine chamber, the operation panel having a plurality of operation buttons at the slanting surface, and amount installed using a sliding member at a lower end of the maching chamber; a rectangular box part having an opened upper portion and connected with the machine part by using a spreadable or foldable leg part; and hooks installed ata front and rear of the machine part and the box part to couple the machine part with the box part.

### Mode for the Invention

Hereinafter, preferred embodiments of the present invention will be described in detail with reference to accompanying drawings.

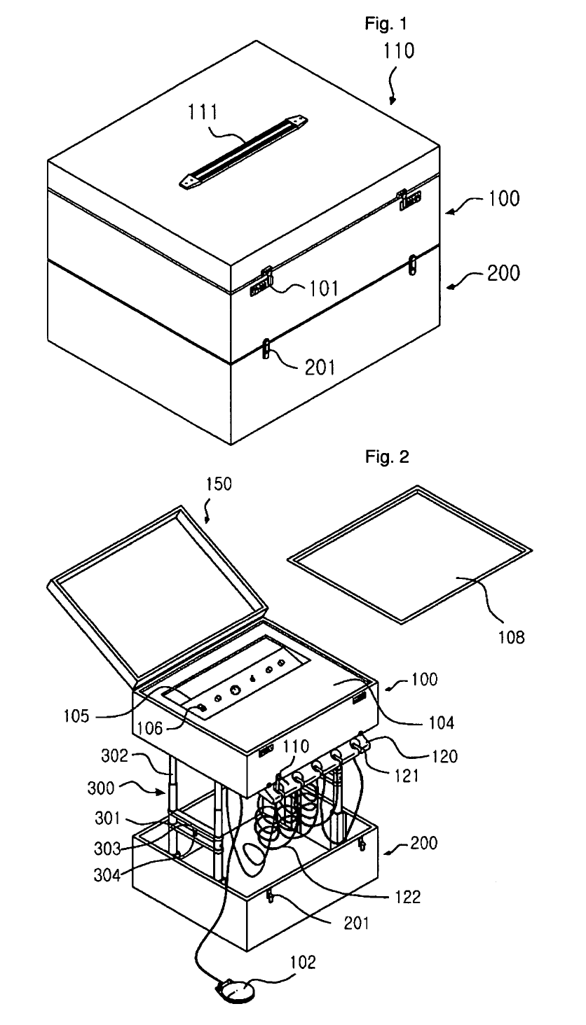

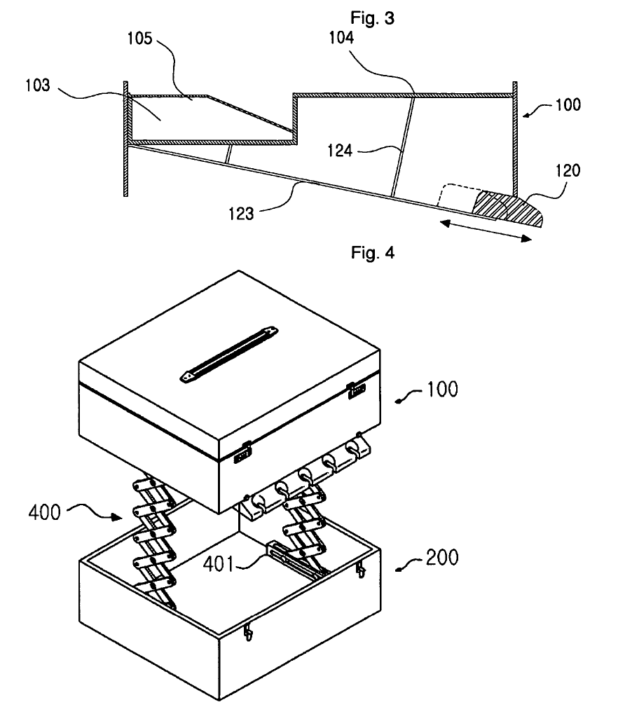

FIG. 1 is a perspective view illustrating a potable dental care stand according to one embodiment of the present invention, FIG. 2 is a view illustrating a used state of the portable dental care stand according to one embodiment of the present invention, and FIG. 3 is a sectional view illustrating the portable dental care stand mounted on a mount according to one embodiment of the present invention.

Referring to FIGS. 1 to 3, the potable dental care stand includes a machine part 100, a box part 200, and a cover part 150 forcovering an upper portion of the machine part 100.

The machine part 100 includes an upper plate 104 covering an upper portion of a rectangular housing, which is opened at the upper portion and a lower portion; a rectangular machine chamber 103 having an opened upper portion and disposed at a predetermiend removed portion of theupper plate 104; and an operation panel 105 having a predetermined slanting surface and installed at the upper portion of the machine chamber 103. The slanting surface of the operation panel 105 has a plurality of operation buttons.

The machine chamber 103 has a control block and a control board to allow air and water to be supplied to a dental clinic tool,and allow air and water to be supplied only to any one dental clinic tool when any one dental clinic tool is used. The machine chamber 103 has two highspeed handpieces, one low speed handpiece, one scaling tool, and one tool for simply supplying air and water. The machine chamber 103 is also connected to an integral type supply line 122 being a power line according to need. The supply line 122 is connected with the machine chamber. The supply line 122 has one end at which a tool coupling part (not shown) is provided to mount the dental clinic tool. Further, a control pedal 102 is connected to operate the tool by pedaling.

The mount 120 is disposed at an end of the sliding member 123 to slide along the sliding member 123. The sliding member 123 is slantingly supported by a support bar 124 connected between a lower end of the machine chamber 103 to the upper plate 104. The mount 120 has five tool mounting openings 121 for mounting the tool coupling parts (not shown)installed at the ends of five supply lines 122. After the dental clinic tool is mounted at the tool coupling part (not shown), it can be mounted at the tool mounting opening 121.

The cover part 150 is provided to cover the upper portion of the machine part 100. A handle 111 is provided at an upper portion of the cover part 150 to grasp and move the dental care stand. A dial type locking unit 101 is installed on a front surface of the cover part 150 to connect and lock the front surface of the cover part 150 with a front surface of the machine part 100. Further, a separable hinge (not shown) is hinged to a rear surface of the cover part 150 and a rear surface of the machine part 100 to fully pull up the cover part 150 from the machine part 100 when the machine part 100 is opened for care.

A rectangular tray 108 can be put on the upper plate 104 to put and use a variety of materials, medicines, tools and the like when the care is performed.

A leg part 300 is installed at both inner side surfaces of the machine part 100. The leg part 300 has a pair of circular rods 302 having steps fomed with a size getting small. The circular rods 302 are connected by a connection bar 303, and the conenction bar 303 is connected with a leg part handle 301 with a spring 304 being interposed therebetween. If the leg part handle 301 is pulled, a ball (not shown) supporting an end of the circular rod 302 is removed to spread out the leg part 300.

The leg part 300 coupled to both inner side surfaces of the machine part 100 is connected and fixed to both inner side surfaces of the box part 200. The box part 200 has a rectangular shape haivng an opened upper portion. When the leg part 300 is spread to couple with the machine part 100, the leg part 300 provides a space for housing the supply line 122, theoperation pedal 102 and the like.

Two hooks 201 are respectively provided at a front surface and a rear surface of the machine part 100 and the box part 200 to couple the machine part 100 with the box part 200.

Hereinafter, a portable dental care stand according to another embodiment of the present invention is in detail described in the following.

FIG. 4 is a perspective view illustrating the potable dental care stand according to another embodiment of the present invention.

As shown in FIG. 4, the portable dental care stand includes the same cover part 150, machine part 100 and box part 200, but a leg part 400 is different from that of the above-described dental care stand.

The leg part 400 includes a movable leg part case 401 at a lower end, and an end of an X-shaped link is fixed to both inner side surfces of the machine part 100 such that the X-shaped link is rotated to support the machine part 100 when the machine part 100 is lifted up.

As such, as means for separating the machine part 100 and the box part 200 from each other to support the machine part 100, a general various spreadable leg part can be used.

Operation states of the above-described embodiments are in detail described with reference to the attached drawings.

As shown in FIG. 1, in a state where the cover part 150, the machine part 100 and the box part 200 are coupled with one another by the locking unit 101 and the hook 201, the handle 111 is used to move the dental care stand to a desired place. If the hook 201 is disconnected at the front and rear of the dental care stand and then, the handle 111 is lifeted up, the leg part 300 is automatically unspread and fixed. At this time, the mount 120 mounted on the sliding member 123 and inserted into the machine part 100 advances to the front due to gravity such that the dental care stand is prepared to mount the tool. Next, after the dial type locking unit 101 is disconnected, the machine part 100 is lifted up using the handle 111 to be separated from the hinge, and the tray 108 is put on the upper plate 104.

After that, if a hose is connected to supply water and a small comress pump is connected to supply a compressed air to the dental care stand, the dental care stand is completely prepared.

After the dental care is finished, the machine part 100 is covered by fitting the cover part 150 to the hinge (not shown) and then,the cover part 150 is locked using the locking unit 101. Next, after the operation pedal 102 and the supply lines 122 are arranged, the mount 120 is pushed into the machine part 100. After that, if the handle 111 is grasped with one hand and the leg part handle 301 is lifted up with the other hand, the leg part 300 is spread to couple the machine part 100 with the box part 200.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention is applicable to a dental examination and treatment in which the dental care can be well performed even in an outside environment.

1. A portable dental care stand comprising:
a cover part having a handle formed at an upper portion;
a machine part connected with the cover part using a separable hinge, and the machine part having:
an upper plate covering an upper portion of a rectangular housing, which is opened at the upper portion and a lower portion,
a rectangular machine chamber having an opened upper portion and disposed at predetermined removed portion of the upper plate,
an operation panel having a predetermined slanting surface and installed at the opened upper portion of the machine chamber, the operation panel having a plurality of operation buttons at the slanting surface, and
a mount installed using a sliding member at a lower end of the machine chamber;
a rectangular box part having an opened upper portion and connected with the machine part using a spreadable or foldable leg part; and
hooks installed at a front and rear of the machine part and the box part to couple the machine part with the box part.

2. The dental care stand of claim 1, wherein the mount is installed to move on the sliding member, which is slantingly installed a support bar connected between a lower portion of the machine chamber and the upper plate.

3. The dental care stand of claim 1, wherein the mount has at least one tool mounting opening to allow a supply line for supplying air, water and power in the machine chamber to be coupled to and installed at a tool coupling part.

4. The dental care stand of claim 1, wherein the leg part has a pair of circular rods having steps formed with a size getting small, the circular rods are connected a connection bar, and the connection bar is connected with a leg part handle with a spring interposed there between.

5. The dental care stand of claim 1, wherein the leg part is comprised of an X-shaped link.
